(19) United States
(12) Patent Application Publication
(10) Pub. No.: US 2007/0206193 A1
(43) Pub. Date: Sep. 6, 2007

(54) Photoacoustic Sensor

(75) Inventor: Benny Pesach, Rosh HaAyin (IL)

Correspondence Address: Martin D Moynihan;Prtsi Inc, P O Box 16446, Arlington, VA, 22215, US

(73) Assignee: Glucon, Inc., Boulder, CO (US)

(21) Appl. No.: 10/597,082

(22) PCT Filed: Jan. 12, 2005
(86) PCT No.: PCT/IL05/00038

§ 371 Date: May 14, 2007

Related U.S. Application Data
(60) Provisional application No. 60/535,832, filed on Jan. 13, 2004.

(51) Int. Cl. G01N 21/00

(52) U.S. Cl. 356/432

(57) ABSTRACT

Apparatus for stimulating photoacoustic waves in a region of a body and generating signals responsive to the stimulated waves comprising: a light source (27) that provides light that stimulates photoacoustic waves (54) in the region; a light pipe (26) having an output aperture (80) and at least one input aperture, which light pipe receives the light from the light source at the at least one input aperture and transmits the received light to illuminate the region from the output aperture; and at least one acoustic transducer (22) that generates signals responsive to acoustic energy from the photoacoustic waves that is incident on the optical output aperture.

### RELATED APPLICATIONS

The present application claims the benefit under 35 USC 119(e) of U.S. provisional application 60/535,832 filed on Jan. 13, 2004, the disclosure of which is incorporated herein by reference.

### FIELD OF THE INVENTION

The invention relates to apparatus for stimulating and sensing photoacoustic waves in a medium.

### BACKGROUND OF THE INVENTION

In a photoacoustic effect, light that illuminates a body is absorbed by a region of the body and a portion of the absorbed optical energy is converted to acoustic energy that propagates away from the absorbing region as acoustic, i.e. “photoacoustic”, waves. The photoacoustic effect is typically used for imaging internal features of a body and/or assaying analytes in the body.

Devices, hereinafter “photoacoustic sensors”, that use the photoacoustic effect to determine a characteristic of a region of a body, generally comprise at least one acoustic transducer and a light provider having an output aperture through which the light provider provides light. The output aperture and the at least one transducer are respectively optically and acoustically coupled to different surface regions of the body. The light provider transmits light from the output aperture that illuminates the body region under investigation with light that is absorbed by material in the body and stimulates photoacoustic waves in the body region. The at least one acoustic transducer receives acoustic energy from the generated photoacoustic waves and generates signals responsive to the received energy. The signals provided by the at least one transducer are used to determine the characteristic.

Often, it is advantageous to couple the at least one acoustic transducer to a surface region of the body which is close to and/or surrounds the surface region to which the light source output aperture is coupled. The at least one acoustic transducer does not receive acoustic energy from photoacoustic waves generated in the body that is incident on the surface region to which the optical output aperture is coupled and the at least one transducer has a “blind spot” at the surface region. The blind spot generally adversely affects sensitivity of the at least one transducer for detecting photoacoustic waves generated in the region and for determining coordinates of the origins of the photoacoustic waves. To an extent that the blind spot is larger, effects of the blind spot on acoustic transducer sensitivity are generally more pronounced. To minimize deleterious effects of the blind spot on sensitivity of the at least one transducer, the output aperture of the light provider is usually made relatively small.

For some applications it is advantageous to aim light provided by a photoacoustic sensor's light provider so that it illuminates a particular feature in a body region. For example, PCT Publication WO 02/15776, the disclosure of which is incorporated herein by reference, describes applications in which it is desirable to illuminate a blood vessel in a region of a patient's body in order to assay an analyte in the patient's blood. However, for a light provider having a small output aperture it can be relatively difficult to aim light from the light provider so that it properly and over an extended period of time consistently illuminates the feature with relatively uniform light intensity.

To reduce difficulty in providing appropriate, stable illumination of features in a body region with a light provider comprised in a photoacoustic sensor, the light provider output aperture is usually made relatively large so that it provides a light beam having a relatively large cross section over which light intensity is relatively uniform. For a relatively large uniform light beam, quality of illumination of a given feature in a body region is relatively less sensitive to accuracy with which the beam is aimed. However, to an extent that the aperture of a photoacoustic sensor's light provider is made larger, the blind spot of the at least one transducer is increased and sensitivity of the transducer for detecting photoacoustic waves and determining their origins is compromised.

An article by P. C. Beard et. al. entitled “Optical Fiber Photoacoustic-Photothermal Probe”, in Optics Letters, Vol. 23, No 15 Aug. 1, 1998 describes a photoacoustic sensor that does not have a blind spot. The photoacoustic sensor comprises an optic fiber an end of which is mounted to a sensor comprising a Fabry-Perot cavity. Light at a first wavelength is transmitted from the end of the fiber through the Fabry-Perot cavity to generate photoacoustic waves in a region of material being probed with the sensor. Acoustic energy from the generated photoacoustic that is incident on the Fabry-Perot cavity changes the cavity's thickness. The thickness of the Fabry-Perot cavity is monitored by light at a second wavelength transmitted into the cavity from the fiber end and changes in the cavity thickness are used to sense the incident photoacoustic energy. The fiber has a core diameter of about 380 microns and the sensor provides a relatively small cross section light beam for stimulating photoacoustic waves.

### SUMMARY OF THE INVENTION

An aspect of some embodiments of the present invention relates to providing alternative configurations of photoacoustic sensors that do not have a blind spot at a location at which the optical output aperture of the sensor's light provider is located.

An aspect of some embodiments of the present invention relates to providing a photoacoustic sensor having a relatively large optical output aperture through which a relatively large cross section beam of light is provided for stimulating photoacoustic waves in a region of material being probed with the sensor.

In accordance with an embodiment of the invention, a photoacoustic sensor comprises a light provider having an optical output aperture formed in a planar light pipe and at least one acoustic transducer. The photoacoustic sensor's at least one acoustic transducer is coupled to the planar light pipe so that acoustic energy incident on the optical output aperture is sensed by the at least one acoustic transducer. The photoacoustic sensor as a result is not “blind” to acoustic energy incident on the optical output aperture and sensitivity of the photoacoustic sensor is therefore substantially unaffected by size of the optical output aperture. The relatively large planar light pipe enables fabrication of relatively large output apertures configured to provide light beams having relatively large cross sections.

In accordance with some embodiments of the present invention, light that exits the light pipe through the output aperture is steerable so that a direction along which the light exits the light pipe is controllable. The steerability of the exiting light reduces aiming constraints on the exiting light and enables features in a relatively large region of material being probed with the sensor to be properly illuminated.

In some embodiments of the present invention, acoustic waves that are incident on the optical output aperture propagate through the light pipe and are incident on the at least one acoustic transducer.

In some embodiments of the present invention, the light pipe is formed from a piezoelectric material. The piezoelectric material functions as a component of the at least one acoustic transducer. Strain in the piezoelectric material responsive to photoacoustic waves incident on the output aperture is sensed and used to generate signals responsive to the photoacoustic waves.

There is therefore provided in accordance with an embodiment of the present invention apparatus for stimulating photoacoustic waves in a region of a body and generating signals responsive to the stimulated waves comprising: a light source that provides light that stimulates photoacoustic waves in the region; a light pipe having an output aperture and at least one input aperture, which light pipe receives the light from the light source at the at least one input aperture and transmits the received light to illuminate the region from the output aperture; and at least one acoustic transducer that generates signals responsive to acoustic energy from the photoacoustic waves that is incident on the optical output aperture.

Optionally the apparatus comprises microprisms formed in the light pipe that reflect the light propagating towards the output aperture so that it exits the light pipe through the output aperture. Additionally or alternatively, the apparatus comprises a Bragg grating formed in the light pipe that receives light propagating towards the output aperture and directs the received light so that it exits the light pipe from the output aperture.

In some embodiments of the invention, the apparatus comprises a holographic lens formed at the output aperture that receives light incident on the output aperture and directs the received light so that it exits the light pipe from the output aperture. Optionally, the holographic lens configures the exiting light into a light beam having a desired shape. Optionally, the light beam is configured by the holographic lens into a substantially cylindrical light beam. Optionally, intensity of light in the light beam is substantially constant over the cross section of the light beam. Optionally, intensity of light in the light beam varies harmonically over the cross section.

In some embodiments of the invention, the apparatus comprises a holographic lens formed at the at least one input aperture that directs light received at the input aperture towards the output aperture.

In some embodiments of the invention, the apparatus comprises a Bragg grating formed in the light pipe that receives light from the input aperture and directs the light towards the output aperture.

In some embodiments of the invention, the apparatus light pipe is planar, having relatively large parallel face surfaces and a relatively narrow edge surface. Optionally, the light received from the light source propagates from the input aperture towards the output aperture along a direction parallel to the plane of the light pipe. Additionally or alternatively an input aperture of the at least one input aperture is located on a face surface of the light pipe. In some embodiments of the invention an input aperture of the at least one input aperture is located on an edge surface of the light pipe.

In some embodiments of the invention, the at least one transducer comprises at least one transducer mounted on a face surface of the light pipe and wherein acoustic energy incident on the output aperture is incident on the at least one transducer after propagating through the light pipe along a direction substantially perpendicular to the face surfaces.

In some embodiments of the invention, the at least one transducer comprises a Bragg grating formed in the light pipe and a light source that illuminates the Bragg grating and wherein an amount of the illuminating light that exits the Bragg grating is responsive to acoustic energy incident on the output aperture of the light pipe.

In some embodiments of the invention, the at least one transducer comprises a Fabry-Perot interferometer formed in the light pipe and a light source that illuminates the interferometer and wherein an amount of the illuminating light that exits the interferometer is responsive to acoustic energy incident on the output aperture of the light pipe.

In some embodiments of the invention, the apparatus comprises input optics controllable to change a direction from which light from the light source is incident on the input aperture. Optionally, a direction along which light that enters the light pipe from the light source exits the output aperture is responsive to the direction from which the light is incident on the input aperture. Additionally or alternatively, the input optics comprises a mirror that receives light from the light source and directs the received light towards the input aperture and the mirror and/or light source is controllable to change the direction from which light is incident on the input aperture. Optionally the apparatus comprises a controller that controls the position of the mirror and/or the light source.

In some embodiments of the invention, the apparatus comprises an optical fiber that transmits the light from the light source to the input aperture. Optionally an end of the optical fiber is bonded to an input aperture of the at least one input aperture.

### BRIEF DESCRIPTION OF FIGURES

Non-limiting examples of embodiments of the present invention are described below with reference to figures attached hereto, which are listed following this paragraph. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A and 1B schematically show a perspective view and a cross-section view respectively of a photoacoustic sensor, in accordance with an embodiment of the present invention.

FIGS. 2A and 2B schematically show respectively a perspective view and a cross section view of a photoacoustic sensor having holographic lenses for coupling light into and out of the sensor, in accordance with an embodiment of the present invention;

FIG. 3 schematically shows a cross section view of a photoacoustic sensor comprising Bragg gratings for coupling light into and out from the sensor, in accordance with an embodiment of the present invention;

FIG. 4 schematically shows a cross section view of a photoacoustic sensor comprising an acoustic transducer that functions as a light pipe, in accordance with an embodiment of the present invention;

FIG. 5 schematically shows a photoacoustic sensor comprising an acoustic transducer that functions as a light pipe, in accordance with an embodiment of the present invention;

FIG. 6 shows a schematic cross section of a photoacoustic sensor in which a Fabry-Perot interferometer is used to sense acoustic energy incident on the sensor, in accordance with an embodiment of the present invention;

FIG. 7 shows a schematic cross section of another photoacoustic sensor, in accordance with an embodiment of the present invention;

FIG. 8 schematically shows a photoacoustic sensor in which a Bragg grating is used to sense acoustic energy incident on the sensor, in accordance with an embodiment of the present invention; and

FIG. 9 schematically shows a photoacoustic sensor for which light that exits the sensor's optical output aperture can be controlled to scan a region of interest, in accordance with an embodiment of the present invention.

### DETAILED DESCRIPTION OF EXEMPLARY EMBODIMENTS

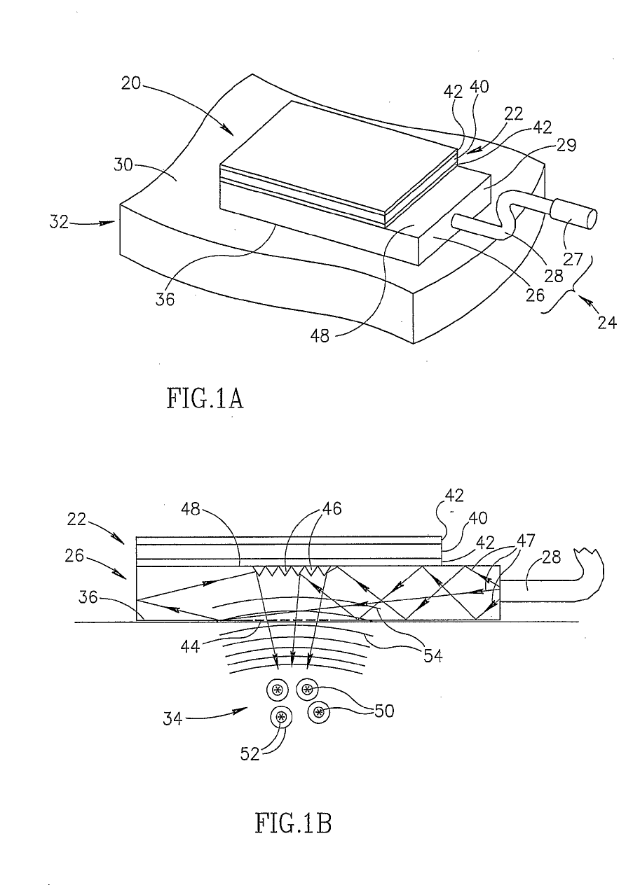

FIGS. 1A and 1B schematically show a perspective view and a cross-section view respectively of a photoacoustic sensor 20, in accordance with an embodiment of the present invention.

Photoacoustic sensor 20 comprises, at least one, optionally planar, acoustic transducer 22 and a light provider 24. Light provider 24 comprises a planar light pipe 26 and optionally an optic fiber 28 coupled to a light source 27 and to the light pipe along an edge surface 29 of the light pipe. Planar light pipe 26 is bonded to at least one transducer 22, which by way of example comprises a single transducer. Photoacoustic sensor 20 is schematically shown coupled to a surface 30 of body 32 so as to generate and sense photoacoustic waves in a region 34 (shown in FIG. 1B) of the body. Coupling of the photoacoustic sensor to surface 30 is achieved by coupling a bottom surface 36 of light pipe 26 to surface 30. Optionally, coupling of the light pipe to surface 30 is aided by use of a suitable gel or adhesive that enhances both optical and acoustic coupling of the light pipe to the skin.

Transducer 22 comprises a layer 40 of piezoelectric material, such as for example PZT or PVDF, sandwiched between two electrodes 42. Acoustic energy that is incident on the piezoelectric material generates a voltage change between electrodes 42, which voltage change is sensed and processed using any of various methods and devices known in the art to characterize the incident acoustic energy and its origin.

Light pipe 26 is formed from a material that is not only optically transparent to light provided by light provider 24 but is also substantially transparent to acoustic waves. Optionally, light pipe 26 is acoustically matched to transducer 22 and surface 30 so that acoustic energy incident on the light pipe from body 32 propagates through the light pipe to the transducer with reduced energy loss. for example, for a given frequency of acoustic energy, to acoustically match light pipe 26 to transducer 22, the light pipe is formed from a material having an acoustic impedance equal to about the square root of the product of the acoustic impedances of transducer 22 and body 32 and having a thickness equal to an odd multiple of a quarter wavelength of the acoustic energy.

Light pipe 26 has an optical output aperture, indicated by a dashed line 44 (FIG. 1B), located on bottom surface 36 of the light pipe through which light that enters the light pipe from optic fiber 28 exits the light pipe. To minimize light leaving light pipe 26 through surface regions of the light pipe other than output aperture 44, light pipe 26 is preferably formed from a material having an index of refraction greater than the indices of refraction of transducer 22 and body 32. Optionally, surface regions of light pipe 26 are covered with a reflective coating (not shown) to reduce unwanted leakage of light from the light pipe.

Light, represented by arrows 47 that enters light pipe 26 from optic fiber 28 is coupled to output aperture 44 so that it exits the aperture using any of various devices known in the art, such as for example microprisms, holographic lenses and/or Bragg gratings. By way of example, light pipe 26 comprises microprisms 46, schematically shown in FIG. 1B, to couple light 47 from optic fiber 28 to output aperture 44. Microprisms 46 are optionally formed on a region of a top surface 48 of light pipe 26 opposite optical aperture 44. Microprisms 46 reflect and refract a portion of light 47 incident on the microprisms towards optical aperture 44 at angles that are greater than the critical angle for the light, so that the light, when it is incident on the optical aperture, exits the light pipe. Microprisms and a manner in which they function to extract light from a light pipe are discussed in U.S. Pat. No. 6,366,409, the disclosure of which is incorporated herein by reference.

To generate and sense photoacoustic waves in region 34, light source 27 is controlled to provide light 47 at a wavelength that stimulates photoacoustic waves in the region. A portion of light 47 that exits optical aperture 44 illuminates and stimulates photoacoustic waves in region 34. In FIG. 1B locations in region 34 at which photoacoustic waves are generated by light 47 are schematically indicated by starbursts 50. Concentric circles 52 about an origin, i.e. a starburst 50, indicate photoacoustic waves radiating away from the origin.

Curved lines 54 schematically indicate acoustic energy from photoacoustic waves 52 that is incident on light pipe 26. Acoustic energy 54 propagates through light pipe 26 until it reaches acoustic transducer 22 where it generates a signal by generating a change in the voltage between electrodes 42. Since acoustic energy incident on substantially any region, including output aperture 44, of bottom surface 36 of light pipe 26 is transmitted to transducer 22, the transducer, and as a result photoacoustic sensor 20, has no blind spot.

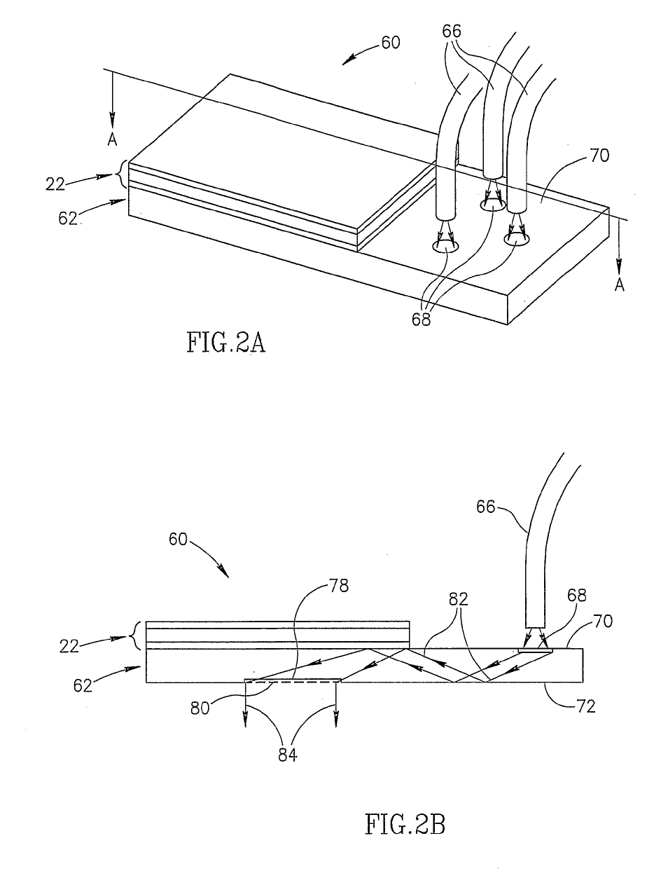

FIGS. 2A and 2B schematically show a perspective view and a cross section view respectively of another photoacoustic sensor 60, in accordance with an embodiment of the present invention. Photoacoustic sensor 60 comprises a light pipe 62 coupled to an acoustic transducer 22 and at least one holographic lens for coupling light into and out of the light pipe. The cross section view shown in FIG. 2B is taken in the plane indicated by line AA in FIG. 2A.

Light pipe 62 has top and bottom surfaces 70 and 72 and receives light from each of a plurality of optic fibers 66. By way of example, the number of the plurality of optic fibers 66 from which light pipe 62 receives light is equal to three. Optionally, each optic fiber 66 is coupled to a light source (not shown) that provides light at a different wavelength. Light from each fiber 66 is coupled into light pipe 62 by a holographic lens 68, optionally formed on top surface 70 of the light pipe.

Each lens 68 is formed using methods known in the art so that it couples light that it receives from its associated optic fiber 66 into light pipe 62 optionally substantially as a plane wave. The plane wave is directed into light pipe 62 at an angle at which light in the plane wave is specularly reflected from top and bottom surfaces 70 and 72 and in a direction towards a same holographic lens 78 (FIG. 2B) formed on a region of the bottom surface. A region indicated by a dashed line segment 80 of bottom surface 72 on which holographic lens 68 is formed functions as an output aperture of the light pipe. Propagation of light rays inserted into light pipe 62 from optic fiber 66 located in plane AA is schematically indicated by lines 82 shown in the cross section view of FIG. 2B.

Holographic lens 78 is formed using methods known in the art to direct the light it receives from each optic fiber 66 so that it exits the light pipe as a light beam, indicated by arrows 84, having a desired size and shape. For example, light beam 84 may be shaped by holographic lens 78 so that it has a desired opening angle and/or expanded so that the beam has a desired cross section. In some embodiments of the present invention holographic lens 78 is formed so that intensity of light in the cross section of light beam 84 is not substantially homogeneous but rather has a desired variation, for example, a sinusoidal variation. An article by T. Sun, et. al. in The Journal of Chemical Physics; Vol 97(12) pp. 9324-9334; Dec. 15, 1992 describes using a sinusoidal variation of light intensity in a material to study viscosity and heat conduction effects in the material. By way of example, in FIG. 2B lens 78 is schematically configured to expand and collimate light that it receives so that beam 84 has a substantially constant cross section of a desired size.

It is noted that in the above description of light pipe 62 holographic lenses 68 and 78 are described as being formed on surfaces 70 and 72 of the light pipe. In some embodiments of the invention holographic lenses 68 and 70 are formed on suitable coatings on surfaces 70 and 72 using methods and devices known in the art. The formation of holographic lenses such as lenses 68 and 78 that operate to insert and extract light from an optical substrate, such as light pipe 62 and applications of such lenses are described in U.S. Pat. No. 5,966,223 the disclosure of which is incorporated herein by reference.

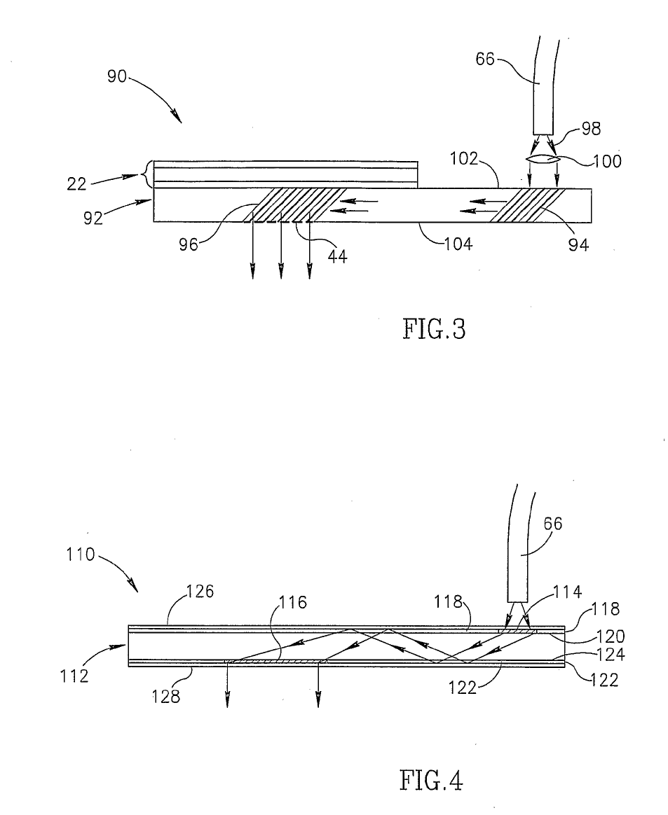

FIG. 3 schematically shows a cross section view of another photoacoustic sensor 90 comprising Bragg gratings for coupling light into and out from a light pipe 92, which is bonded to a transducer 22, in accordance with an embodiment of the present invention.

Light pipe 92 is assumed to be formed from a suitable photorefractive material so that it may be formed with a first Bragg grating 94 and a second Bragg grating 96, using methods known in the art. Light 98 from an optic fiber 66 is optionally collimated by an appropriate lens 100 and enters light pipe 92 at a location on an upper surface 102 of the light pipe at which it is incident on Bragg grating 94. Bragg grating 94 diffracts light 98 so that it is directed towards Bragg grating 96. Bragg grating 96 diffracts the light it receives so that it exits light pipe 92 through an output aperture region of light pipe 92 indicated by a dashed line segment 44 on a bottom surface 104 of the light pipe. It is noted that whereas lens 100 is shown separate from light pipe 92 in some embodiments of the invention, lens 100 is a holographic lens formed in the material from which the light pipe is formed or on a suitable coating on the light pipe.

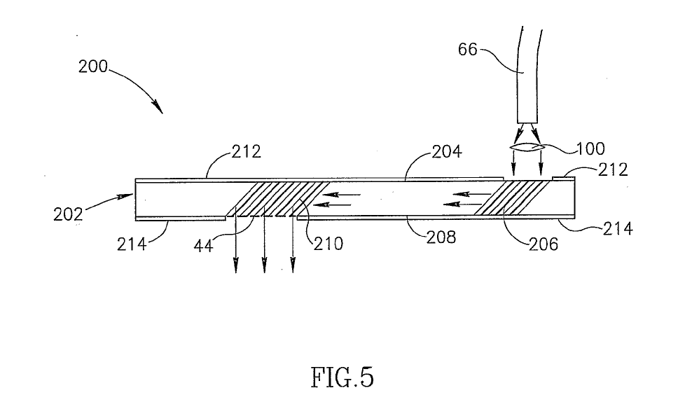

FIG. 4 schematically shows a cross section view of a photoacoustic sensor 110 comprising an acoustic transducer 112 that functions as a light pipe (or alternatively a light pipe 112 that functions as a transducer), in accordance with an embodiment of the present invention.

Transducer 112 is formed from a material that is optically transparent to light that is used with the sensor to stimulate photoacoustic waves in a material to which the sensor is attached. A suitable material from which to form transducer 112 is PVDF, which is substantially transparent to UV light in a wavelength range from about 400 nm to about 1800 nm. PVDF also has an index of refraction equal to about 1.455, which allows light inserted into a body formed from the material to be trapped therein by internal reflection. Other materials suitable for providing an acoustic transducer that also functions as a light pipe are LiNbO3, PZT or Quartz.

Light is optionally inserted into transducer 112 from an optic fiber 66 and extracted from the transducer using holographic lenses 114 and 116 respectively, similarly to the manner in which light is inserted and extracted from light pipe 62 in photoacoustic sensor 60 shown in FIG. 2B. Lenses 114 and 116 may be formed in the material from which transducer 112 is formed or optionally on a suitable coating on the surfaces of the transducer. In photoacoustic sensor 110, by way of example, holographic lenses 114 and 116 are formed respectively on a coating 118 on a top surface 120 of transducer 112 and on a coating 122 on a bottom surface 124 of the transducer.

Electrodes 126 and 128 are optionally formed on coatings 118 and 122 respectively to sense changes in voltage generated by transducer 112 responsive to acoustic energy incident on the transducer. To prevent electrodes 126 and 128 from substantially interfering with insertion of light into and extraction of light out from transducer 112, optionally, the electrodes are formed from a transparent material, such as for example ITO. Alternatively or additionally, electrodes 126 and 128 may be formed so that they do not cover holographic lenses 114 and 116. In some embodiments of the invention, coatings 118 and 122 in which holographic lenses 114 and 116 are formed are deposited only in regions of top and bottom surfaces 120 and 124 where the lenses are located. Electrodes 126 and 128 are deposited directly on top and bottom surfaces 120 and 124 respectively but not on regions of the surfaces on which the material in which lenses 114 and 116 are formed is deposited.

Generally, since acoustic energy incident on transducer 112 affects propagation of light in the transducer, light is not propagated through transducer 112 simultaneously with incidence of photoacoustic waves on the transducer.

FIG. 5 schematically shows another photoacoustic sensor 200 comprising an acoustic transducer 202 that functions as a light pipe, in accordance with an embodiment of the present invention. Light is optionally inserted into transducer 202 on a region of a top surface 204 of the transducer, optionally from an optic fiber 66, using a lens 100 and a Bragg grating 206. Light is extracted from transducer 202 from an output aperture 44 on a bottom surface 208 of the transducer using a Bragg grating 210. Coupling of light into and out from transducer 202 is similar to the manner in which light is coupled into and out from light pipe 92 in photoacoustic sensor 90 shown in FIG. 3. Electrodes 212 and 214 are used to sense voltage changes generated by transducer 202 responsive to acoustic energy incident on the transducer. As in the case of photoacoustic sensor 110, electrodes 212 and 214 may be formed from a transparent conducting material and/or, be formed so that they do not cover regions of surfaces 204 and 208 through which light is introduced and extracted from transducer 202.

In the above examples of photoacoustic sensors comprising a transducer that functions as a light pipe, light is coupled into and out of the transducer using holographic lenses or Bragg gratings. Other methods for coupling light to the transducer may of course be used. In general, any method suitable for coupling light into and out of a light pipe comprised in a photoacoustic sensor for which the light pipe and acoustic transducer are different elements, may be used for coupling light into and out of a transducer that also functions as a light pipe. For example, an optic fiber may be directly bonded to a surface of the light pipe to insert light into the light pipe and microprisms may be used to direct light to a suitable optical output aperture to extract light from the transducer.

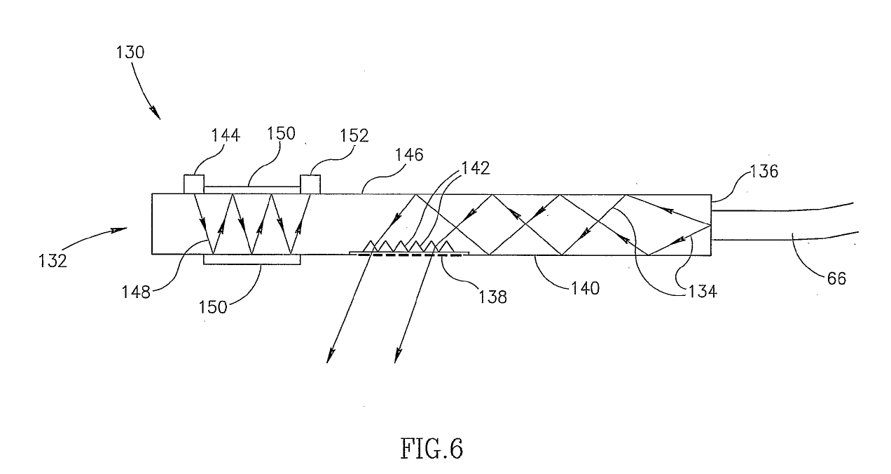

FIG. 6 shows a schematic cross section of another photoacoustic sensor 130 in accordance with an embodiment of the invention.

Photoacoustic sensor 130 comprises an acoustic transducer 132 that functions also as a light pipe. By way of example light represented by “arrowed” lines 134 is introduced into the light pipe by an optic fiber 66 coupled directly to an edge surface 136 of the transducer. Light 134 is extracted from the light pipe through an output aperture indicated by a dashed line 138 on a region of a bottom surface 140 of the transducer optionally using microprisms 142, which are formed, by way of example, on the aperture region.

To generate signals responsive to acoustic energy incident on transducer 130, a source of coherent light, such as a laser 144 optionally directly coupled to a top surface 146 of transducer 132, inserts a beam 148 of coherent light into the transducer. Appropriate reflective coatings 150 on top surface 146 and bottom surface 140 repeatedly reflect light in light beam 148 back and forth between the surfaces. A sensor 152, optionally optically coupled to top surface 146, senses intensity of the reflected light. Transducer 132 and reflective coatings 150 function as a Fabry-Perot interferometer and intensity of the sensed light is responsive to a distance between the reflective coatings, which distance changes responsive to acoustic energy incident on the transducer.

Whereas in FIG. 6 the Fabry-Perot interferometer comprising reflective surface 150 and its associated laser 144 and sensor 152 are laterally displaced relative to output aperture 138, in some embodiments of the invention reflective surface 150 associated laser 144 and sensor 152 are directly opposite the output aperture. For such a configuration, wavelength of light 148 provided by laser 144 is chosen so that prism 142 functions in place of reflective surface 150 to reflect the light to sensor 152. FIG, 7 schematically shows a photoacoustic sensor 160 similar to photoacoustic sensor 130 but having its Fabry-Perot cavity opposite output aperture 138.

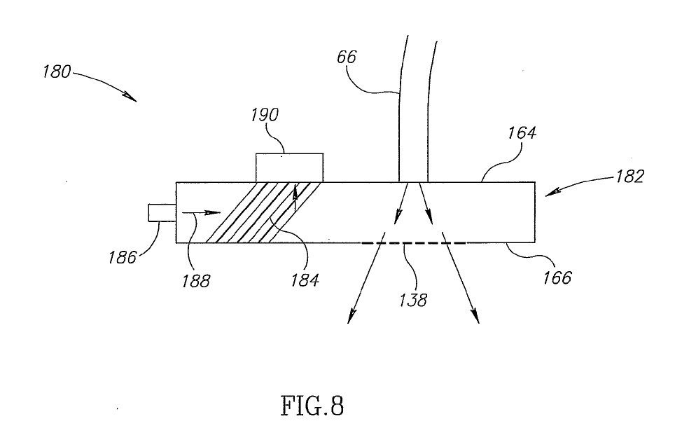

FIG. 8 schematically shows yet another photoacoustic sensor 180 in accordance with an embodiment of the invention. Photoacoustic sensor 180 comprises an acoustic transducer 182 that functions as a light pipe and a Bragg grating 184 that is used to sense acoustic energy incident on the transducer. An optic fiber 66 for inserting light into transducer 182 is optically coupled to a region of a top surface 164 of the transducer directly opposite an output aperture 138 on a bottom surface 166 of the transducer. Light from fiber 66 that enters transducer 182 propagates through the transducer directly to the output aperture to exit the transducer.

A suitable light source 186 transmits a coherent beam of light 188 into transducer 182 that is incident on Bragg grating 184. The Bragg grating diffracts light 188 towards a sensor 190 coupled to top surface 164 of transducer 182 that generates signals responsive to intensity of the diffracted light that it receives. The intensity of the diffracted light is a function of the wavelength of light 188 and distance between the planes of Bragg grating 184, which distance changes in response to acoustic energy incident on transducer 182.

In some embodiments of the invention, Bragg grating 184 is located directly over output aperture 138. Wavelength of light 188 is chosen so that the Bragg grating reflects the light to sensor 190, which is located adjacent to and optionally surrounding the region of surface 164 to which optic fiber 66 is coupled. Wavelength of light transmitted from optic fiber 66 to stimulate photoacoustic waves in a material is chosen so that the Bragg grating is substantially transparent to the light from the fiber.

In some embodiments of a photoacoustic sensor in accordance with the present invention, light that exits the sensor's output aperture is steerable so that the beam can be controlled to scan a region of interest in a body to which the photoacoustic sensor is attached.

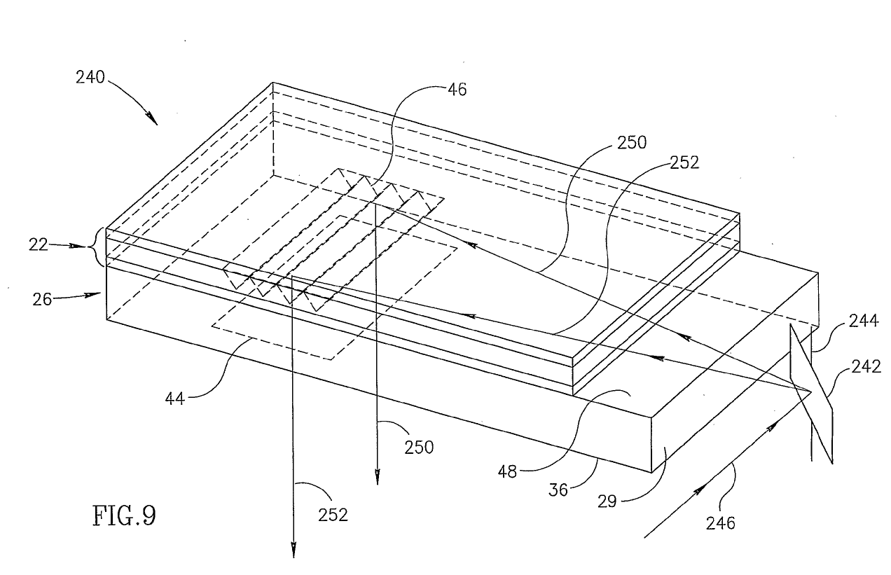

FIG. 9 schematically shows a photoacoustic sensor 240 for which light that exits the sensor's optical output aperture is steerable so that it can be used to scan a region of interest. Features of photoacoustic sensor 240 that are germane to the discussion and are hidden in the perspective of FIG. 9 are shown in ghost lines.

Photoacoustic sensor 240 is similar to photoacoustic sensor 20 shown in FIGS. 1A and 1B and comprises a light pipe 26 and an acoustic transducer 22. Light pipe 26 is optionally formed with microprisms 46 for extracting light from light pipe 240. Microprisms 46 are by way of example assumed to be relatively long prisms having a triangular cross section that are formed on a top surface 48 of light pipe 26 and have their long dimension substantially parallel to an edge surface 29 of the light pipe. Microprisms 46 direct light that enters light pipe 26 through edge surface 29 to exit the light pipe through an output aperture 44 shown in ghost lines on a bottom surface 36 of the light pipe. Light that enters light pipe 26 is extracted from the light pipe by microprisms 46 similarly to the way in which light is extracted from light pipe 26 shown in FIG. 1B.

However, unlike photoacoustic sensor 20, in photoacoustic sensor 240 light is introduced into light pipe 26 by a micromirror 242 rotatable about an axis 244 perpendicular to the plane of the light pipe. Micromirror 242 receives light along a direction indicated by arrow 246 from a suitable light source (not shown) and reflects the light into light pipe 26 through edge surface 29 of the light pipe. Light reflected by micromirror 242 is incident on edge surface 29 and enters light pipe 26 at an angle that depends upon the angular position of the micromirror about axis 244. For different angles of incidence, light that is inserted into light pipe 26 by micromirror 242 is incident on microprisms 46 at different regions along the length of the microprisms. For different regions of incidence along microprisms 46 light leaves light pipe 26 from different locations in output aperture 44 that lie substantially along a direction parallel to the lengths of the microprisms. As a result, by changing the angle of micromirror 242, light from light pipe 26 illuminates different portions of a region of interest in a body to which photoacoustic sensor 240 is attached and the photoacoustic sensor can be controlled to scan the region of interest. In some embodiments of the present invention, microprisms 46, which are shown as straight prisms in FIG. 9 are curved and lie substantially along arcs of a circle having a center located substantially at a virtual image of the light source that illuminates mirror 242. The curved prisms cause light from the light source to exit light pipe 26 parallel to substantially a same direction for each position of mirror 242.

FIG. 9 schematically shows the general directions of propagation paths for light 250 and 252 reflected by micromirror 242 -at two different substantially extreme angular positions of micromirror 242. Light 250 and 252 exit light pipe 26 at opposite ends of outlet aperture 44.

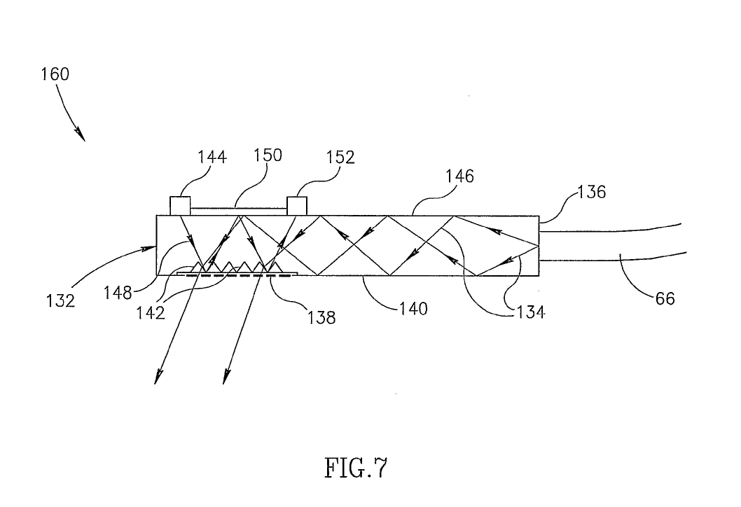

Photoacoustic sensor 240 provides scanning along a single direction. In some embodiments of the present invention scanning can be performed along two orthogonal directions. For example, in a photoacoustic sensor similar to photoacoustic sensor 160 shown in FIG. 7 optic fiber 66 may, instead of being mounted directly to the sensor's transducer 132 be mounted to a steering apparatus using methods and devices known in the art. The steering apparatus is controllable to orient fiber 66 so that it inserts light into transducer 132 along different directions. Optionally, the steering apparatus can control the fiber orientation so as to control both an azimuth angle and a declination angle of a direction along which light from the fiber enters transducer 132. As a result, direction along which light exits transducer 132 through aperture 138 be controlled so that the light scans a region of interest along two different directions.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. Apparatus for stimulating photoacoustic waves in a region of a body and generating signals responsive to the stimulated photoacoustic waves comprising:
a light source that provides light that stimulates photoacoustic waves in the region;
a light pipe having an output aperture and at least one input aperture, which light pipe receives the light from the light source at the at least one input aperture and transmits the received light from the output aperture to illuminate the region; and
at least one acoustic transducer that generates signals responsive to acoustic energy from the photoacoustic waves that is incident on the optical output aperture.

2. Apparatus according to claim 1 and comprising microprisms formed in the light pipe that reflect the light propagating towards the output aperture so that it exits the light pipe through the output aperture.

3. Apparatus according to claim 1 and comprising a Bragg grating formed in the light pipe that receives light propagating towards the output aperture and directs the received light so that it exits the light pipe from the output aperture.

4. Apparatus according to claim 1 and comprising a holographic lens formed at the output aperture that receives light incident on the output aperture and directs the received light so that it exits the light pipe from the output aperture.

5. Apparatus according to claim 4 wherein the holographic lens configures the exiting light into a light beam having a desired shape.

6. Apparatus according to claim 5 wherein the light beam is configured by the holographic lens into a substantially cylindrical light beam.

7. Apparatus according to claim 6 wherein intensity of light in the light beam is substantially constant over the cross section of the light beam.

8. Apparatus according to claim 6 wherein intensity of light in the light beam varies harmonically over the cross section.

9. Apparatus according to claim 1 and comprising a holographic lens formed at the at least one input aperture that directs light received at the input aperture towards the output aperture.

10. Apparatus according to claim 1 and comprising a Bragg grating formed in the light pipe that receives light from the input aperture and directs the light towards the output aperture.

11. Apparatus according to claim 1 wherein the light pipe is planar, having relatively large parallel face surfaces and a relatively narrow edge surface.

12. Apparatus according to claim 11 wherein the light received from the light source propagates from the input aperture towards the output aperture along a direction parallel to the plane of the light pipe.

13. Apparatus according to claim 11 wherein an input aperture of the at least one input aperture is located on a face surface of the light pipe.

14. Apparatus according to claim 11 wherein an input aperture of the at least one input aperture is located on an edge surface of the light pipe.

15. Apparatus according to claim 11 wherein the at least one transducer comprises at least one transducer mounted on a face surface of the light pipe and wherein acoustic energy incident on the output aperture is incident on the at least one transducer after propagating through the light pipe along a direction substantially perpendicular to the face surfaces.

16. Apparatus according to claim 1 wherein the at least one transducer comprises a Bragg grating formed in the light pipe and a light source that illuminates the Bragg grating and wherein an amount of the illuminating light that exits the Bragg grating is responsive to acoustic energy incident on the output aperture of the light pipe.

17. Apparatus according to claim 1 wherein the at least one transducer comprises a Fabry-Perot interferometer formed in the light pipe and a light source that illuminates the interferometer and wherein an amount of the illuminating light that exits the interferometer is responsive to acoustic energy incident on the output aperture of the light pipe.

18. Apparatus according to claim 1 and comprising input optics controllable to change a direction from which light from the light source is incident on the input aperture.

19. Apparatus according to claim 18 wherein a direction along which light that enters the light pipe from the light source exits the output aperture is responsive to the direction from which the light is incident on the input aperture.

20. Apparatus according to claim 18 wherein the input optics comprises a mirror that receives light from the light source and directs the received light towards the input aperture and the mirror and/or light source is controllable to change the direction from which light is incident on the input aperture.

21. Apparatus according to claim 17 and comprising a controller that controls the position of the mirror and/or the light source.

22. Apparatus according to claim 1 and comprising an optical fiber that transmits the light from the light source to the input aperture.

23. Apparatus according to claim 19 wherein an end of the optical fiber is bonded to an input aperture of the at least one input aperture.
